(19) United States
(12) Patent Application Publication
(10) Pub. No.: US 2026/0175795 A1
(43) Pub. Date: Jun. 25, 2026

(54) Grommet

(71) Applicant: Illinois Tool Works Inc., Glenview, IL (US)

(72) Inventors: Jiahui He, Shanghai (CN); Zhilin Li, Shanghai (CN)

(21) Appl. No.: 19/425,808

(22) Filed: Dec. 18, 2025

(30) Foreign Application Priority Data
Dec. 20, 2024 (CN) 202411895827.3
Dec. 12, 2025 (CN) 202511881697.2

(51) Int. Cl. B60R 13/02; F16B 5/06

(52) U.S. Cl. CPC B60R 13/0206; F16B 5/0621

(57) ABSTRACT

The present disclosure relates to a grommet for mounting in an opening of a panel or similar structure. The grommet includes a main body that defines a central passage and one or more flexible retaining arms arranged along an outer wall of the main body. The retaining arms are configured to flex during installation and engage the surrounding structure to hold the grommet in place. A sealing material is provided between the retaining arms and the main body to close gaps while still allowing the arms to flex as needed. This arrangement provides improved resistance to rotation after installation and helps maintain effective sealing between the interior and exterior of the grommet, reducing the likelihood of fluid, dust, or air passing through the mounted opening.

### RELATED APPLICATIONS

The present application claims the benefit of Chinese Patent Application Nos. 202411895827.3, filed Dec. 20, 2024, and 202511881697.2, filed Dec. 12, 2025, each titled “Grommet,” the contents of which are hereby incorporated by reference.

### TECHNICAL FIELD

The present disclosure relates to the technical field of assembly of vehicle components, and in particular to a grommet for mounting a vehicle component to a body sheet metal.

### BACKGROUND

During vehicle production and assembly, it is often necessary to use various grommets to fixedly mount vehicle components (e.g., door trim panels) to designated positions on the body sheet metal in order to complete the assembly of the various components to produce a complete vehicle. These grommets need to have both good fastening and sealing effects for certain portions of the vehicle to meet the requirements of vehicle assembly. Therefore, there is a need for a grommet which itself has a good sealing effect and which helps an assembly worker to fix a component to be mounted onto the vehicle sheet metal easily, quickly and reliably.

### SUMMARY

The present disclosure relates generally to a grommet, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 is a perspective view of a grommet of the present disclosure.

FIGS. 2A, 2B, 2C, 2D and 2E are respectively a perspective view, a side view, a cross-sectional view, a bottom view and a top view of a main body of the grommet shown in FIG. 1.

FIGS. 3A, 3B, 3C and 3D are respectively a perspective view, a side view, a bottom view and a top view of a seal 300 of the grommet shown in FIG. 1.

FIGS. 4A, 4B, 4C, and 4D are respectively a side view, a cross-sectional view, a bottom view and a top view of the grommet 100 shown in FIG. 1.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

The currently used grommet is of an integrally injection-molded structure, in which an interior of the grommet is not in communication with an exterior thereof. By providing arm structures at certain positions of the grommet (for example, at ridge edges), the grommet can be snap-fitted onto a vehicle body panel after being inserted into the vehicle body panel, thereby fixing vehicle components to the vehicle body and enabling a good sealing effect at an installation position. However, providing the arm structures at the ridge edges of the grommet damages the original ridge edge structure, resulting in insufficient anti-rotation strength of the grommet after insertion into the vehicle body panel. As a result, the grommet may rotate at the assembled position, thereby reducing the fastening effect and the sealing performance.

Accordingly, there is a need for a grommet in which corresponding arm structures are provided without damaging the ridge edge structure of the grommet itself, such that the grommet can be conveniently snap-fitted and fixed to the vehicle body panel, while ensuring that the grommet has good sealing performance, thereby preventing external dust, rainwater, and the like from entering an interior of the vehicle body panel through the installation position.

In order to at least partially solve the above technical problems, according to a first aspect of the present application, there is provided a grommet, including: a main body, the main body includes: a side wall defining a channel, a plurality of openings being provided on the side wall; a neck collar disposed at a head of the side wall; and a plurality of arms connected to the side wall at the plurality of openings by proximal ends thereof that are away from the neck collar, respectively, a gap being provided between an edge of each of the arms and an edge of a corresponding one of the openings; and a seal including a plurality of first seal portions, each of the first seal portions connecting an edge of a corresponding one of the arms to an edge of a corresponding one of the openings to fill the gap therebetween, while allowing the at least one arm to deflect relative to the side wall.

In some embodiments, the edge of each of the arms includes a first arm edge and a second arm edge opposite each other, the edge of each of the openings includes a first opening edge and a second opening edge opposite each other, and at least one of the first arm edge, the second arm edge, the first opening edge and the second opening edge is provided with at least one limiting structure; and the first seal portion includes limited structures that fit in shape with the limiting structures on the first arm edge, the second arm edge, the first opening edge and the second opening edge, respectively.

In some embodiments, the limiting structure is a dovetail groove, and the limited structure is a dovetail block.

In some embodiments, the edge of each of the arms further includes a third arm edge at a distal end of the arm, the third arm edge includes an uneven arm connecting surface, and the first seal portion includes a seal connecting surface that fits in shape with the arm connecting surface of the third arm edge.

In some embodiments, a step-shaped engaging surface is provided on an outer side of each of the arms.

In some embodiments, a driving bevel is further provided on the outer side of each of the arms, the driving bevel being connected to the engaging surface and located between the engaging surface and a tail of the side wall; wherein the driving bevel extends obliquely outward in a direction toward the engaging surface.

In some embodiments, the at least one arm includes an arm body and a protrusion portion disposed on an outer side of the arm body, the protrusion portion forming the engaging surface and the driving bevel; wherein when the at least one arm is in a non-deflected state, the arm body is located within the corresponding opening.

In some embodiments, the side wall has an outer surface shaped as a prism, and the side wall includes a first wall portion and a second wall portion opposite each other, and a third wall portion and a fourth wall portion opposite each other; wherein the opening is formed on each of the first wall portion and the second wall portion; and the plurality of arms include a pair of arms, the pair of arms being connected to the first wall portion and the second wall portion, respectively.

In some embodiments, the seal further includes a second seal portion, the second seal portion at least partially covering the neck collar and forming a seal lip facing the side wall.

In some embodiments, the main body is made of a relatively rigid material, the seal is made of an elastomer material, and the main body and the seal are integrally formed by a two-component injection molding process.

Additional aspects and advantages of the present application will be partly set forth in the description below, partly become apparent from the description, or may be learned through practice of the present application.

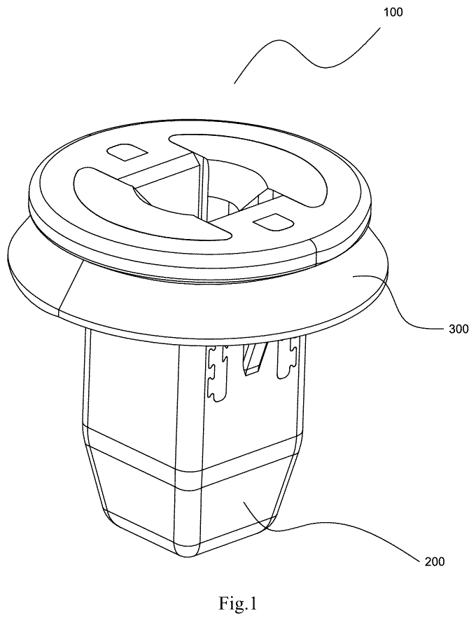

FIG. 1 is a perspective view of a grommet 100 of the present disclosure.

As shown in FIG. 1, according to an embodiment of the present disclosure, the grommet 100 includes a main body 200 and a seal 300. The main body 200 and the seal 300 are integrally formed by a two-component injection molding process. During the injection molding, the main body 200 and seal 300 are made of different materials. The main body 200 needs to be made of a relatively rigid material to achieve an anti-rotation function. The seal 300 needs to be made of a relatively flexible material to achieve a sealing function. For example, the main body 200 is made of a plastic material and the seal 300 is made of an elastic rubber material. In some other embodiments, the main body 200 and the seal 300 may be made of other suitable materials, provided that they satisfy the corresponding fastening and sealing functions. A chemical adhesive is provided between the main body 200 and the seal 300 to ensure a tight bonding between the two. The two-component injection molding process reduces the design space and the number of components, thereby lowering engineering costs. In addition, the grommet 100 has higher quality and strength due to the integration between the main body 200 and the seal 300 through chemical bonding. Various components of a vehicle are fixed to the body sheet metal (not shown) of the vehicle by means of the grommet 100.

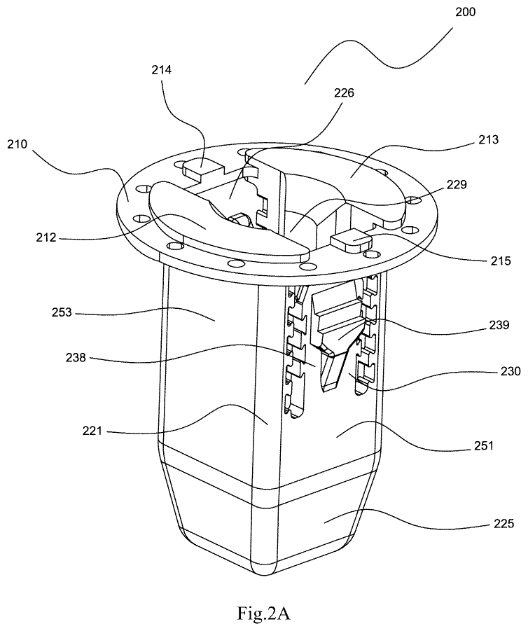

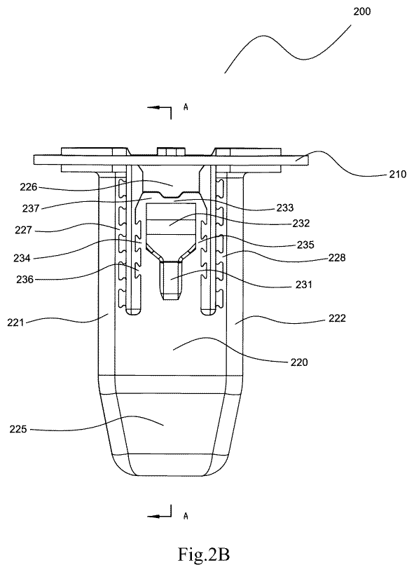

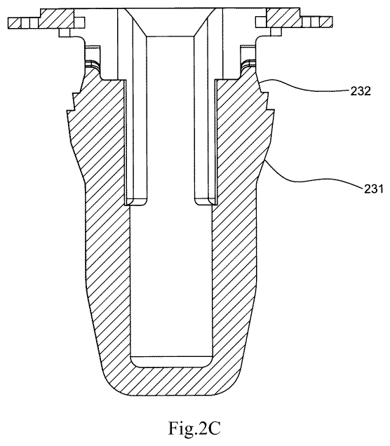

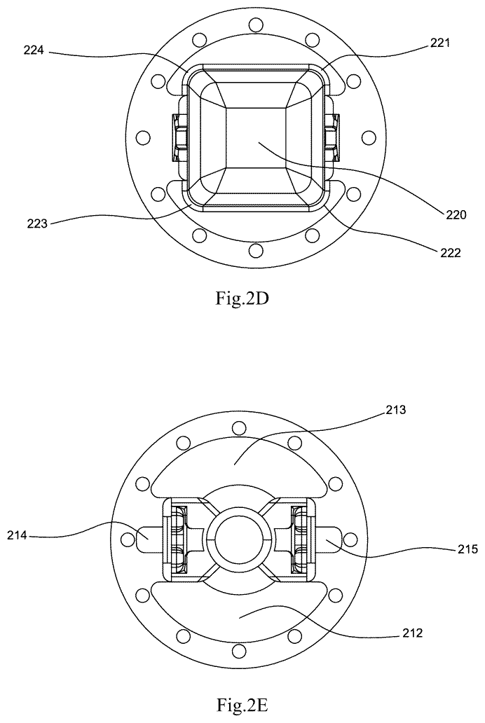

FIGS. 2A, 2B, 2C, 2D and 2E are respectively a perspective view, a side view, a cross-sectional view, a bottom view and a top view of a main body 200 of the grommet 100 shown in FIG. 1.

As shown in FIG. 2A, according to an embodiment of the present disclosure, the main body 200 includes a neck collar 210 and a side wall 220 extending from the neck collar 210, where a head of the side wall 220 is connected to the neck collar 210, and a tail of the side wall is configured to be inserted into a receiving structure (e.g., a square hole) provided on the body sheet metal until the neck collar 210 abuts against a surface of the body sheet metal. As shown in FIGS. 2A and 2E, the neck collar 210 is shaped as a disc, with a plurality of circular through-holes provided along an outer edge of the disc for better connection with the seal 300 to be described later, thereby improving the connection strength. Moreover, two pairs of protrusions 212, 213 and 214, 215 are disposed on one side surface of the neck collar 210 and are configured to fit in shape with corresponding structures on the seal 300 to be described later, where the protrusions 212 and 213 are semicircular and disposed opposite each other, and the protrusions 214 and 215 are disposed opposite each other and located between the protrusions 212 and 213.

As shown in FIGS. 2A, 2B and 2D, the other side surface of the neck collar 210 is connected to the head of the side wall 220, and the side wall 220 has an outer surface shaped as a prism, and has four complete edges 221, 222, 223 and 224. The side wall 220 includes a first wall portion 251 and a second wall portion 252 (not shown) opposite each other and a third wall portion 253 and a fourth wall portion 254 (not shown) opposite each other. The four wall portions define a channel 229. An opening 226 is provided on each of the first wall portion 251 and the second wall portion 252, and an arm 230 is provided in the opening 226. FIGS. 2A and 2B only illustrate the opening 226 on the first wall portion 251. It should be understood by those skilled in the art that the number of the openings and the arms may be set according to actual requirements. As shown in FIGS. 2A and 2B, the arm 230 has a proximal end that is away from the neck collar 210 and a distal end that is close to the neck collar 210. The arm 230 is connected to the first wall portion 251 at the opening 226 by the proximal end thereof, and the distal end of the arm is a free end which is elastically deflectable relative to the first wall portion 251.

As shown in FIGS. 2A and 2B, the arm 230 includes an arm body 238 and a protrusion portion 239 provided on an outer side of the arm body 238. An edge of the arm body 238 includes a first arm edge 234 and a second arm edge 235 opposite each other axially. An edge of the opening 226 includes a first opening edge 227 and a second opening edge 228 opposite each other axially. The first arm edge 234, the second arm edge 235, the first opening edge 227 and the second opening edge 228 each are provided with a plurality of limiting structures 236. As an embodiment, the limiting structures 236 are dovetail grooves. The limiting structures 236 at the first opening edge 227 and the second opening edge 228 are formed only on the outer surface of the side wall 220 and are not in communication with the channel 229 inside the side wall 220. It should be understood by those skilled in the art that the number and specific shape of limiting connection portions can be adjusted according to actual requirements. The edge of the arm body 238 further includes a third arm edge 233 at the distal end of the arm 230, and the third arm edge 233 includes an uneven arm connecting surface 237. When the arm 230 is in a non-deflected state, the arm body 238 is located within the opening 226. The arm body 238 has an outer surface that protrudes outward to form the protrusion portion 239. The protrusion portion 239 includes a driving bevel 231 formed by extending obliquely outward from a position close to the proximal end of the arm 230 and a step-shaped engaging surface 232 that is connected to the driving bevel 231 and formed by extending inward toward the distal end of the arm 230. The driving bevel 231 is configured to drive the arm 230 to deflect relative to the side wall 220 in the process of inserting the grommet 100 into the square hole on the body sheet metal, and the engaging surface 232 is configured to abut against an edge of the square hole when the grommet 100 is inserted into the square hole on the body sheet metal. As shown in FIGS. 2A and 2B, according to an embodiment of the present disclosure, the driving bevel 231 has a width less than that of the arm body 238, to lower the risk of flash in the subsequent two-component injection molding process.

As shown in FIGS. 2A, 2B and 2D, a guide portion 225 is provided at the tail of the side wall 220 and is configured to guide the insertion of the grommet 100 into the square hole on the body sheet metal. In the process of inserting the grommet 100 into the square hole on the body sheet metal, the guide portion 225 first comes into contact with the square hole and then the edge of the square hole abuts against the driving bevel 231 of the arm 230. As the grommet 100 is further inserted, the driving bevel 231 of the arm 230 is compressed radially inward under an abutting force, thereby causing the entire arm 230, especially the distal end (the free end) of the arm 230 to deform radially inward. When the edge of the square hole slides over a highest point of the protrusion portion 239 of the arm 230, the arm 230 rebounds radially outward by a certain stroke under elastic stress until the engaging surface 232 abuts against the edge of the square hole. As shown in FIGS. 2A, 2B and 2C, according to an embodiment of the present disclosure, the engaging surface 232 has a three-step engaging portion, with steps radially contracting inward in sequence to adapt to different sheet metal thicknesses. It should be understood by those skilled in the art that the number of steps of the engaging surface 232 may be adjusted according to specific requirements, for example, there may be a one-step, two-step or multi-step engaging portion. When the grommet 100 is inserted into the square hole on the body sheet metal, the four edges 221, 222, 223 and 224 of the side wall 220 fit in shape with four corners of the square hole respectively, to prevent the grommet 100 from rotating in the square hole, thereby achieving the anti-rotation function of a fastener. Finally, a screw is inserted into the channel 229 defined by the side wall 220 and tightened, thereby fixing a component to be fastened onto the neck collar 210 to form fastening.

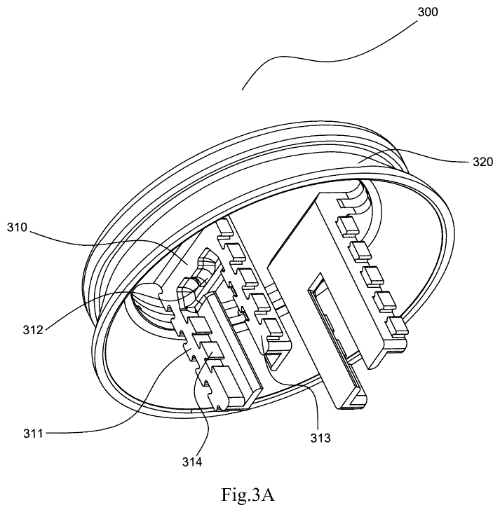

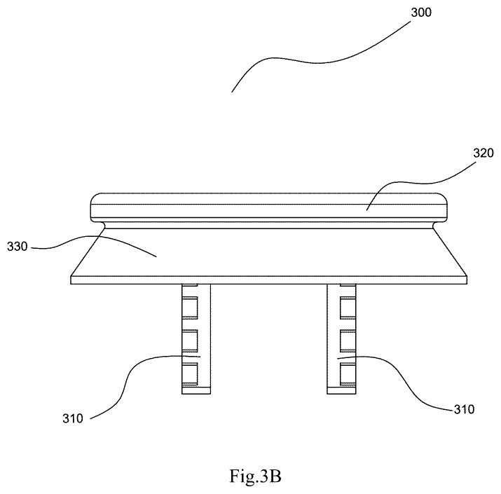

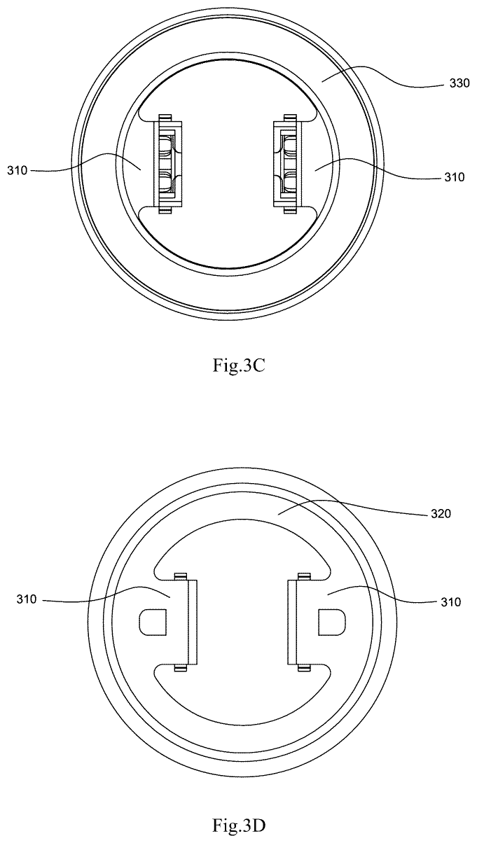

FIGS. 3A, 3B, 3C and 3D are respectively a perspective view, a side view, a bottom view and a top view of a seal 300 of the grommet 100 shown in FIG. 1.

As shown in FIGS. 2A, 2B, and 2C, a gap formed between an edge of the arm 230 and a corresponding edge of the opening 226 enables communication between the interior and exterior of the main body 200. In order to achieve a waterproof sealing effect, the seal 300 needs to be filled in the gap. As shown in FIGS. 3A and 3B, the seal 300 includes a pair of first seal portions 310 and a second seal portion 320 that is substantially annular. The first seal portions 310 are connected to the second seal portion 320 and are formed by axially extending from the second seal portion 320. Each first seal portion 310 includes a first seal strip 311 that fits in shape with a gap between the first arm edge 234 and the first opening edge 227 shown in FIG. 2B, a second seal strip 313 that fits in shape with a gap between the second arm edge 235 and the second opening edge 228 shown in FIG. 2B, and a seal connecting surface 312 that fits in shape with the arm connecting surface 237 of the third arm edge 233 shown in FIG. 2B. The first seal strip 311 and the second seal strip 313 each are formed with limited structures 314 that fit in shape with the plurality of limiting structures 236 shown in FIG. 2B. As the plurality of limiting structures shown in the embodiment of FIG. 2B are dovetail grooves, the limited structures here are dovetail blocks fitting with the dovetail grooves in shape. The first seal portion 310 connects an edge of a corresponding arm 230 to an edge of a corresponding opening 226 to fill the gap therebetween, while allowing the arm 230 to deflect relative to the side wall 220. It should be understood by those skilled in the art that the number and position of the first seal portions 310 may be set according to actual requirements, as long as they can fit in shape with the arms 230 provided on the main body 200 to achieve the connecting and sealing effects. The second seal portion 320 at least partially covers the neck collar 210 of the main body 200 and forms a seal lip 330 facing the side wall 220. As shown in FIG. 3D, opening structures on an upper surface of the second seal portion 320 fit in shape with the two pairs of protrusions 212, 213 and 214, 215 shown in FIGS. 2A and 2E, thereby enabling the seal 300 and the main body 200 to be mounted tightly.

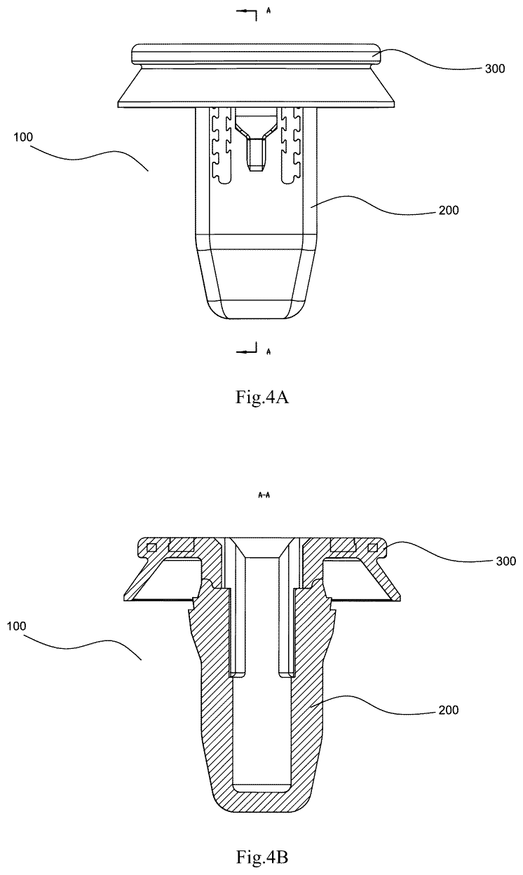

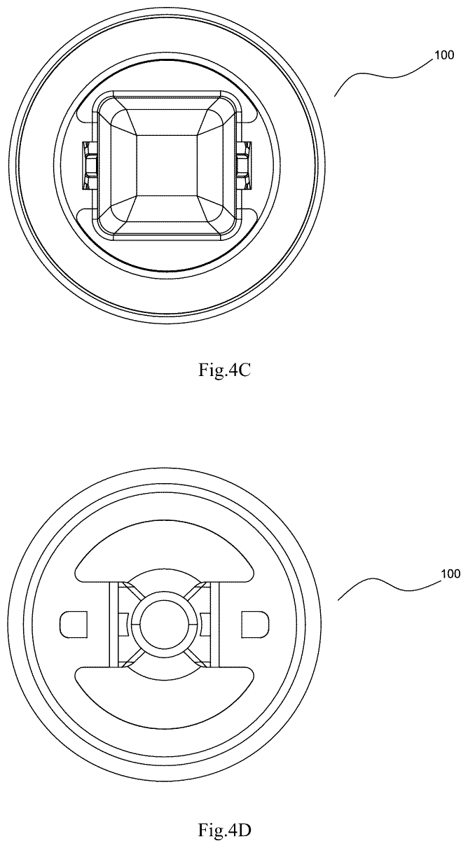

FIGS. 4A, 4B, 4C, and 4D are respectively a side view, a cross-sectional view, a bottom view and a top view of the grommet 100 shown in FIG. 1.

As shown in FIGS. 4A and 4B, when the main body 200 and the seal 300 are integrally molded by the two-component injection molding process to form the grommet 100, the seal 300 and the main body 200 are bonded by a chemical adhesive, and since the arm 230 will elastically deflect during insertion of the grommet 100 into the sheet metal, the seal 300 connected to the arm 230 is thus pulled to deform together. In this case, the limiting structures provided at the edges of the opening 226 and the arm 230 (e.g., the dovetail grooves 236 in FIG. 2B) and the limited structures formed on the seal 300 (e.g., the dovetail blocks 314 in FIG. 3A) fit with each other, thereby improving the firmness of connection between the main body 200 and the seal 300, and preventing the arm 230 from separating from the seal 300 during deformation. It should be understood by those skilled in the art that no limiting structures may be provided at the edges of the opening 226 and the arm 230, and no limited structures may be provided on the seal 300, as long as the requirement of firm connection between the main body 200 and the seal 300 is met. Furthermore, the third arm edge 233 formed at the free end of the arm 230 as shown in FIG. 2C is also embedded in a corresponding structure of the seal 300, thereby further preventing the main body 200 from disengaging from the seal 300 while lowering the risk of flash in the two-component injection molding process. When the main body 200 is in structural fit with the seal 300, the interior and exterior of the grommet 100 are not in communication, enabling a good sealing effect.

The grommet of the present disclosure has the following advantages.

In the prior art, an arm structure is provided at an edge of the grommet, which may disrupt the original edge structure, resulting in insufficient anti-rotation strength after the grommet is inserted into the body sheet metal, and causing rotation of the grommet in an assembly position, thereby reducing the fastening and sealing effects. According to the grommet 100 of the present disclosure, an arm structure is provided on the side wall 220 of the main body 200, enabling the grommet 100 to have a complete edge structure, thereby achieving a better anti-rotation function. In addition, in the present disclosure, when the main body 200 is in structural fit with the seal 300, the interior and exterior of the grommet 100 are not in communication, thereby enabling a good sealing effect.

Although the present application has been described with reference to exemplary embodiments of the above overview, various alternatives, modifications, variations, improvements, and/or equivalents, whether known or now or hereafter devised, will be apparent to those of ordinary skill in the art. Furthermore, the technical effects and/or technical problems described in the present application are exemplary and not restrictive; accordingly, the disclosure of the present application may be applied to solve other technical problems and achieve other technical effects and/or may be applied to solve other technical problems. Therefore, the exemplary embodiments of the present application described above are intended to be illustrative rather than restrictive. Various changes may be made without departing from the spirit or scope of the present application. Accordingly, the present application is intended to encompass all known or previously developed alternatives, modifications, variations, improvements, and/or equivalents.

What is claimed is:

1. A grommet, comprising:
a main body, the main body comprising:
a side wall defining a channel, a plurality of openings being provided on the side wall;
a neck collar disposed at a head of the side wall; and
a plurality of arms connected to the side wall at the plurality of openings by proximal ends thereof that are away from the neck collar, respectively, a gap being provided between an edge of each of the arms and an edge of a corresponding one of the openings; and
a seal comprising a plurality of first seal portions, each of the first seal portions connecting an edge of a corresponding one of the arms to an edge of a corresponding one of the openings to fill the gap therebetween, while allowing the at least one arm to deflect relative to the side wall.

2. The grommet according to claim 1, wherein
the edge of each of the arms comprises a first arm edge and a second arm edge opposite each other, the edge of each of the openings comprises a first opening edge and a second opening edge opposite each other, and at least one of the first arm edge, the second arm edge, the first opening edge and the second opening edge is provided with at least one limiting structure; and
the first seal portion comprises limited structures that fit in shape with the limiting structures on the first arm edge, the second arm edge, the first opening edge and the second opening edge, respectively.

3. The grommet according to claim 2, wherein
the limiting structure is a dovetail groove, and the limited structure is a dovetail block.

4. The grommet according to claim 1, wherein
the edge of each of the arms further comprises a third arm edge at a distal end of the arm, the third arm edge comprises an uneven arm connecting surface, and the first seal portion comprises a seal connecting surface that fits in shape with the arm connecting surface of the third arm edge.

5. The grommet according to claim 1, wherein
a step-shaped engaging surface is provided on an outer side of each of the arms.

6. The grommet according to claim 5, wherein
a driving bevel is further provided on the outer side of each of the arms, the driving bevel being connected to the engaging surface and located between the engaging surface and a tail of the side wall;
wherein the driving bevel extends obliquely outward in a direction toward the engaging surface.

7. The grommet according to claim 5, wherein
the at least one arm comprises an arm body and a protrusion portion disposed on an outer side of the arm body, the protrusion portion forming the engaging surface and the driving bevel;
wherein when the at least one arm is in a non-deflected state, the arm body is located within the corresponding opening.

8. The grommet according to claim 1, wherein
the side wall has an outer surface shaped as a prism, and the side wall comprises a first wall portion and a second wall portion opposite each other, and a third wall portion and a fourth wall portion opposite each other;
wherein the opening is formed on each of the first wall portion and the second wall portion; and
the plurality of arms comprise a pair of arms, the pair of arms being connected to the first wall portion and the second wall portion, respectively.

9. The grommet according to claim 1, wherein
the seal further comprises a second seal portion, the second seal portion at least partially covering the neck collar and forming a seal lip facing the side wall.

10. The grommet according to claim 1, wherein
the main body is made of a relatively rigid material, the seal is made of an elastomer material, and the main body and the seal are integrally formed by a two-component injection molding process.

11. A grommet, comprising:
a rigid main body including a side wall that defines a central channel and includes at least one opening formed through the side wall;
at least one resilient arm extending along the side wall and having a proximal end coupled to the side wall adjacent the opening and a distal end configured to deflect relative to the side wall; and
an elastomeric seal material disposed between the arm and the side wall at the opening,
wherein the seal material spans a gap between the arm and the side wall while permitting elastic deflection of the arm relative to the side wall, and
wherein the seal material maintains a fluid-tight seal during deflection of the arm.

12. The grommet according to claim 11, wherein the arm is partially received within the opening when in a non-deflected state and moves outwardly from the opening when deflected.

13. The grommet according to claim 11, wherein the opening defines opposing opening edges and the arm defines opposing arm edges, and wherein the seal material mechanically interlocks with at least one of the arm edges or the opening edges.

14. The grommet according to claim 13, wherein the mechanical interlock comprises complementary dovetail-shaped features formed between the seal material and at least one of the arm or the side wall.

15. The grommet according to claim 11, wherein the arm includes an outwardly facing engaging surface configured to engage a panel or mounting structure when the grommet is installed.

16. The grommet according to claim 15, wherein the engaging surface is step-shaped and configured to resist withdrawal of the grommet from the mounting structure.

17. The grommet according to claim 15, wherein the arm further includes a driving bevel positioned between the engaging surface and a trailing end of the side wall, the driving bevel being angled to facilitate insertion of the grommet into an opening.

18. The grommet according to claim 11, wherein the side wall has a polygonal outer profile including a first wall portion and a second wall portion opposite one another, and wherein respective arms are coupled to the first wall portion and the second wall portion.

19. The grommet according to claim 11, further comprising a neck collar formed at a leading end of the side wall, the neck collar being configured to seat against a surface of a panel when the grommet is installed.

20. The grommet according to claim 19, wherein the seal material further includes a seal lip formed over at least a portion of the neck collar and oriented toward the side wall to enhance sealing against the panel.
